(19) United States
(12) Patent Application Publication
(10) Pub. No.: US 2017/0096443 A1
(43) Pub. Date: Apr. 6, 2017

(54) PLATINUM(IV) COMPOUNDS AND METHODS OF MAKING AND USING SAME

(71) Applicant: UNIVERSITY OF GEORGIA RESEARCH FOUNDATION, INC., Athens, GA (US)

(72) Inventors: Shanta Dhar, Miami, FL (US); Rakesh Pathak, Columbus, OH (US); Vladimir V. Popik, Watkinsville, GA (US); Christopher D. McNitt, Athens, GA (US)

(21) Appl. No.: 15/123,432

(22) PCT Filed: Mar. 4, 2015
(86) PCT No.: PCT/US2015/018720

§ 371 Date: Sep. 2, 2016

Related U.S. Application Data
(63) Continuation-in-part of application No. PCT/US2014/069997, filed on Dec. 12, 2014.
(60) Provisional application No. 61/976,559, filed on Apr. 8, 2014.
(60) Provisional application No. 61/947,703, filed on Mar. 4, 2014.

(51) Int. Cl. C07F 15/00

(52) U.S. Cl. CPC C07F 15/0093

(57) ABSTRACT

Reactions of 1,3-dipole-functional (e.g., azide-functional) platinum(IV) compounds with cyclic alkynes under conditions effective for a cycloaddition reaction to form a heterocyclic compound are disclosed herein. In certain embodiments, the conditions effective for the cycloaddition reaction to form the heterocyclic compound includes the substantial absence of added catalyst (e.g., copper catalyst).

This application claims the benefit of U.S. Provisional Application No. 61/947,703, filed Mar. 4, 2014, which is hereby incorporated by reference in its entirety.

### GOVERNMENT FUNDING

This invention was made with government support under grant number W81XWH-12-1-0406, awarded by the Department of Defense of the United States government; and grant number R01CA157766 awarded by the National Institute of Health. The government has certain rights in the invention.

### BACKGROUND

Prostate cancer (PCa) is the most frequently diagnosed cancer and the second leading cause of cancer death in men in the United States. Patients with PCa inevitably progress to hormone-independent disease. PCa that progresses in the presence of androgen blockade is defined as Castration-Resistant Prostate Cancer (CRPC). Cis-diamminedichloroplatinum(II) or cisplatin is currently one of the most effective anticancer drugs available for treating a variety of solid tumors. Resistance to apoptotic death is a characteristic feature of advanced PCa and is one of the reasons for the failure of cisplatin-based therapeutic strategy of hormone refractory disease.

There is a need for cisplatin type drugs that incorporate different therapeutic modalities to circumvent resistance in particular cancer types.

### SUMMARY

In one aspect, the present disclosure provides a method of preparing a heterocyclic compound. In one embodiment, the method includes: providing at least one 1,3-dipole-functional platinum(IV) compound; contacting the at least one 1,3-dipole functional platinum(IV) compound with at least one cyclic alkyne; and allowing the at least one 1,3-dipole-functional platinum(IV) compound and the at least one cyclic alkyne to react under conditions effective for a cycloaddition reaction to form the heterocyclic compound.

An exemplary 1,2-dipole-functional platinum(IV) compound can be of the formula:

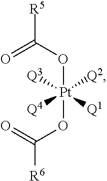

wherein: each Q¹, Q², Q³, and Q⁴ independently represents a neutral or negatively charged ligand, with the proviso that at most two of Q¹, Q², Q³, and Q⁴ can represent negatively charged ligands, and wherein two or more of Q¹, Q², Q³, and Q⁴ can optionally be joined to form one or more five- or six-membered platinocyclic rings (e.g., monocyclic rings, bicyclic rings, tricyclic rings, and the like); and R⁵ and R⁶ each independently represent an organic group, with the proviso that at least one of R⁵ and R⁶ includes a 1,3-dipole-functional group. For embodiments in which two of Q¹, Q², Q³, and Q⁴ represent negatively charged ligands, the resulting platinum(IV) compound is neutral. For embodiments in which only one of Q¹, Q², Q³, and Q⁴ represents a negatively charged ligand, the resulting platinum(IV) compound bears a single positive charge (+1), and the platinum (IV) compound is a salt that includes a single negatively charged (−1) counterion (e.g., NO₃⁻, HSO₄⁻, and the like). For embodiments in which none of Q¹, Q², Q³, and Q⁴ represents a negatively charged ligand, the resulting platinum(IV) compound bears a positive charge of +2, and the platinum (IV) compound is a salt that includes a single counter ion having a charge of −2 (e.g., SO₄⁻², and the like), or two single negatively charged (−1) counterions (e.g., NO₃⁻, HSO₄⁻, combinations thereof, and the like).

A wide variety of negatively charged ligands can be useful, including, for example, those known as negatively charged ligands for Pt(II) compounds such as cisplatin, carboplatin, oxaliplatin, picoplatin, aroplatin, nedaplatin, lobaplatin, pyriplatin, spiroplatin, quinoplatin, phenanthriplatin, and the like. Exemplary negatively charged ligands include, for example, halides (e.g., Cl⁻, Br⁻, etc.), alkoxides and aryloxides (e.g., RO⁻), carboxylates (e.g., RC(O)O⁻), sulfates (e.g., RSO₄⁻), and the like, wherein each R individually represents H or an organic group.

A wide variety of neutral ligands can be useful, including, for example, those known as neutral ligands for Pt(II) compounds such as cisplatin, carboplatin, oxaliplatin, picoplatin, aroplatin, nedaplatin, lobaplatin, pyriplatin, spiroplatin, quinoplatin, phenanthriplatin, and the like. Exemplary neutral ligands include, for example, R₃N, wherein each R individually represents H or an organic group, wherein two or more R groups can optionally be joined to form one or more rings; and nitrogen-containing heteroaromatics (e.g., pyridine, quinoline, phenanthridine, and the like).

In some embodiments, two negatively charged ligands; two or more neutral ligands; and/or two or more neutral and negatively charged ligands may be combined to form bidentate ligands, tridentate ligands, and/or tetradentate ligands.

In some embodiments, an exemplary 1,2-dipole-functional platinum(IV) compound can be of the formula:

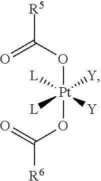

wherein: each Y independently represents a negatively charged ligand, wherein both Y ligands may optionally be joined to form a five- or six-membered platinocyclic ring; each L independently represents a neutral ligand, wherein both L ligands may optionally be joined to form a five- or six-membered platinocyclic ring; and R⁵ and R⁶ each independently represent an organic group, with the proviso that at least one of R⁵ and R⁶ includes a 1,3-dipole-functional group.

In some embodiments, the at least one cyclic alkyne is selected from the group consisting of cyclooctynes, monoarylcyclooctynes, and diarylcyclooctynes (e.g., a dibenzocyclooctyne). In some embodiments, the conditions effective for a cycloaddition reaction to form the one or more heterocyclic compounds include the substantial absence of added catalyst.

In another aspect, the present disclosure provides a compound of the formula:

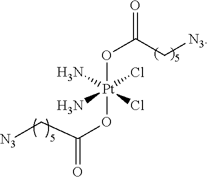

In yet another aspect, the present disclosure provides heterocyclic compounds that include a platinum(IV) compound. In some embodiments, the heterocyclic compounds can be prepared by methods discussed herein above. Exemplary heterocyclic compounds are further discussed herein.

### Definitions:

The term “comprises” and variations thereof do not have a limiting meaning where these terms appear in the description and claims.

As used herein, “a,” “an,” “the,” “at least one,” and “one or more” are used interchangeably.

As used herein, the term “or” is generally employed in the sense as including “and/or” unless the context of the usage clearly indicates otherwise.

Also herein, the recitations of numerical ranges by endpoints include all numbers subsumed within that range (e.g., 1 to 5 includes 1, 1.5, 2, 2.75, 3, 3.80, 4, 5, etc.).

The above summary is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 is a schematic illustration of the preparation of exemplary platinum(IV) compounds using a SPAAC-based platform to form Pt(IV) prodrugs form a single platinum precursor. “X” represents a targeting moiety, an adjuvant, an antibody, another therapeutic, a fluorescent reporter, a dye, a sensor, or the like.

FIG. 2 is a schematic illustration of the preparation of ADIBO-COOH and exemplary platinum(IV) compounds Platin-Az and Platin-CLK using Cu(I)-free click chemistry.

FIG. 3 illustrates (a) a schematic representation of the preparation of an exemplary platinum(IV) compound with a fluorescent reporter; and (b) a representation of live cell imaging of PC₃ cells in the presence of Platin-Cy5.5 (scale bar 25 μm).

FIG. 4 is an illustration of the size, zeta potential, loading, EE, and morphology of Platin-CLK-loaded PLGA-b-PEG-nanoparticles (NPs).

FIG. 5 is an illustration of cyclic voltammograms of Platin-Az and Platin-CLK in 1:4 dimethylformamide (DMF)-phosphate buffer-0.1 M KCl at two different pH values.

FIG. 6 is an illustration of by matrix-assisted laser desorption/ionization (MALDI)-time of flight (TOF)-mass spectrometry (MS) chromatogram of a Pt-GG adduct obtained by the reaction of Platin-CLK and 5′-GMP in the presence of sodium ascorbate. The isotopic peak pattern confirms the presence of platinum species in the Pt-GG adduct.

FIG. 7 is a graphical representation of data from a cell survival analyses using 3-(4,5-dimethylthiazol-2-yl)-2,5-diphenyltetrazolium bromide (MTT) in PC3 and DU145 cells.

FIG. 8 is an exemplary UV-visible spectrum of Patin-Cy5.5 in DMF and its comparison with that of ADIBO-CY5.5 and Platin-Az. This comparison indicates the disappearance of ADIBO-specific absorbance plateau from the region of 265-315 nm and the appearance of the peak at 685 nm for the Cy5.5 moiety in Platin-Cy5.5.

FIG. 9 are illustrations of exemplary gel permeation chromatographic (GPC) chromatograms of PLGA-b-PEG-OH, PLGA-COOH, and HO-PEG-OH in THF.

FIG. 10 illustrates exemplary dynamic light scattering (DLS) data for Platin-CLK loaded NPs.

### DETAILED DESCRIPTION OF ILLUSTRATIVE EMBODIMENTS

Design and development of platform technology for construction of Platinum(IV) prodrugs with functionalities for conjugation to targeting moieties, delivery systems, fluorescent reporters from a single precursor with the ability to release biologically active cisplatin using well-defined chemistry may be important for discovering new platinum based therapeutics. Therefore, a versatile Pt(IV) prodrug, Platin-Az has been synthesized to incorporate, for example, new azadibenzocyclooctyne (ADIBO) functionalities on cisplatin platform using Cu(I) free click chemistry approach technically known as a strain promoted azide alkyne cycloaddition (SPAAC) reaction. This technology may allow easy and highly efficacious incorporation of different therapeutic modalities on cisplatin platform to circumvent its resistance in particular cancer types.

With the limited number of possibilities by considering sensitivity of Pt(IV) centers to reduction, thiols, etc, a Cu(I) free strain promoted azide alkyne cycloaddition approach was used to provide a novel platform where new functionalities can easily be installed on cisplatin prodrugs from a single Pt(IV) precursor. The ability of this platform to be incorporated in nanodelivery vehicle and conjugation to fluorescent reporters were also investigated.

In simple language using this technology, one can incorporate a wide variety of molecular systems to the cisplatin, which can make it a better therapeutic option. Further, by introducing the ADIBO moiety, these prodrugs can acquire sufficient hydrophobic characteristics to offer utility in clinical translation through polymeric nanoparticle formulation.

Therefore, present disclosure describes the synthesis and evaluation of new Pt(IV) prodrugs using a SPAAC reaction approach. This technology provides a common platform to functionalize Pt(IV) prodrugs with a wide variety of molecules of interest.

The discovery of cis-diamminedichlorido-platinum(II) or cisplatin (e.g., Rosenberg et al., Nature 1969, 222:385; and Wang et al., Nat. Rev. Drug Discov. 2005, 4:307) and its huge success in the treatment of a variety of tumors led the exploration of new platinum compounds. The need for new platinum complexes with remarkable anticancer properties and selectivity to reduce side effects and overcome resistance shown by cisplatin demand the ability to install targeting moieties, delivery systems, and/or a second therapeutic on platinum center (e.g., Wilson et al., Chem. Rev. 2013, DOI: 10.1021/cr4004314). The biological activity of cisplatin begins with aquation inside cell with the loss of one or both chloride ligands to generate highly electrophilic platinum(II) aqua complexes that readily react with biological nucleophiles including the N7 position of purine DNA bases resulting intra and inter-strand cross-links with nuclear DNA (e.g., Dijt et al., Cancer Res. 1988, 48:6058; and Todd et al., Metallomics 2009, 1:280). This series of biological activities imposes limitation on the strategies to synthesize new Pt(II) complexes. The non-leaving group ligands which stay bound to the Pt(II) center upon DNA binding offer only limited modifications without affecting the biological activity (e.g., Wilson et al., Chem. Rev. 2013, DOI: 10.1021/cr4004314). The desire for a good leaving group for aquation introduces further limitations on the incorporation of new functionalities on Pt(II) centers.

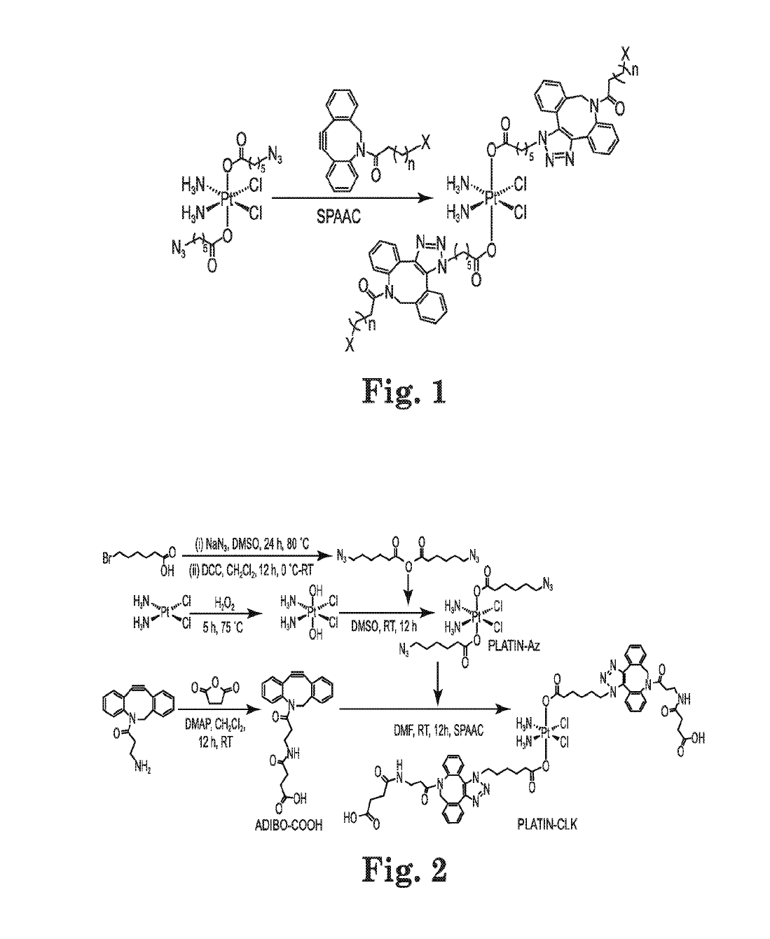

Kinetically ‘inert’ Pt(IV) prodrugs with two available axial sites can be an attractive way to introduce new functionalities on platinum. Pt(IV) compounds show biological activities which involve reduction to Pt(II) prior to DNA binding (e.g., Kelland et al., J. Inorg. Biochem. 1999, 77:111; and Hall et al., J. Med. Chem. 2007, 50:3403). The ability to rationally design and construct a platform technology to develop new platinum(IV) prodrugs using synthetic chemistry from a single precursor can be of enormous benefit for discovering new therapeutics. Anhydrides are widely used as electrophiles for installation of new functionalities on relatively weak nucleophilic Pt(IV)-OH. However, all anhydrides are not stable and a large number of molecules of interest lack acid functionality for transformation to anhydrides. Click chemistry can be a convenient way to introduce multiple ligands. However, possibility of Pt(IV) reduction by Cu(I) catalyst of the copper-catalyzed azide-alkyne cycloaddition (CuAAC) and cytotoxicity of remaining copper are factors limiting the utility of CuAAC-click reaction for synthesis and applications of Pt(IV) prodrugs. Only a limited number of examples have documented CuAAC-click reaction on Pt(IV) compounds (e.g., Zhang et al., Chem. Eur. J. 2013, 19:1672). With such issues in mind, we describe a platform technology by using Cu(I) free strain promoted azide alkyne cycloaddition (SPAAC) approach, a single Pt(IV) precursor Platin-Az, and functionalized azadibenzocyclooctyne (ADIBO) derivatives for easy installation of new functionalities on Pt(IV) centers in a single step (e.g., FIG. 1).

In one aspect, the present disclosure provides a method of preparing a heterocyclic compound. In one embodiment, the method includes: providing at least one 1,3-dipole-functional platinum(IV) compound; contacting the at least one 1,3-dipole functional platinum(IV) compound with at least one cyclic alkyne; and allowing the at least one 1,3-dipole-functional platinum(IV) compound and the at least one cyclic alkyne to react under conditions effective for a cycloaddition reaction to form the heterocyclic compound.

An exemplary 1,2-dipole-functional platinum(IV) compound can be of the formula:

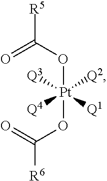

wherein: each Q¹, Q², Q³, and Q⁴ independently represents a neutral or negatively charged ligand, with the proviso that at most two of Q¹, Q², Q³, and Q⁴ can represent negatively charged ligands, and wherein two or more of Q¹, Q², Q³, and Q⁴ can optionally be joined to form one or more five- or six-membered platinocyclic rings (e.g., monocyclic rings, bicyclic rings, tricyclic rings, and the like); and R⁵ and R⁶ each independently represent an organic group, with the proviso that at least one of R⁵ and R⁶ includes a 1,3-dipole-functional group. For embodiments in which two of Q¹, Q², Q³, and Q⁴ represent negatively charged ligands, the resulting platinum(IV) compound is neutral. For embodiments in which only one of Q¹, Q², Q³, and Q⁴ represents a negatively charged ligand, the resulting platinum(IV) compound bears a single positive charge (+1), and the platinum (IV) compound is a salt that includes a single negatively charged (−1) counterion (e.g., NO₃⁻, HSO₄⁻, and the like). For embodiments in which none of Q¹, Q², Q³, and Q⁴represents a negatively charged ligand, the resulting platinum(IV) compound bears a positive charge of +2, and the platinum (IV) compound is a salt that includes a single counter ion having a charge of −2 (e.g., SO₄⁻², and the like), or two single negatively charged (−1) counterions (e.g., NO₃⁻, HSO₄⁻, combinations thereof, and the like).

A wide variety of negatively charged ligands can be useful, including, for example, those known as negatively charged ligands for Pt(II) compounds such as cisplatin, carboplatin, oxaliplatin, picoplatin, aroplatin, nedaplatin, lobaplatin, pyriplatin, spiroplatin, quinoplatin, phenanthriplatin, and the like. Exemplary negatively charged ligands include, for example, halides (e.g., Cl⁻, Br⁻, etc.), alkoxides and aryloxides (e.g., RO⁻), carboxylates (e.g., RC(O)O⁻), and sulfates (e.g., RSO₄⁻), and the like, wherein each R individually represents H or an organic group.

A wide variety of neutral ligands can be useful, including, for example, those known as neutral ligands for Pt(II) compounds such as cisplatin, carboplatin, oxaliplatin, picoplatin, aroplatin, nedaplatin, lobaplatin, pyriplatin, spiroplatin, quinoplatin, phenanthriplatin, and the like. Exemplary neutral ligands include, for example, R₃N, wherein each R individually represents H or an organic group, wherein two or more R groups can optionally be joined to form one or more rings; and nitrogen-containing heteroaromatics (e.g., pyridine, quinoline, phenanthridine, and the like).

In some embodiments, two negatively charged ligands; two or more neutral ligands; and/or two or more neutral and negatively charged ligands may be combined to form bidentate ligands, tridentate ligands, and/or tetradentate ligands.

An exemplary 1,2-dipole-functional platinum(IV) compound can be of the formula:

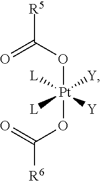

wherein: each Y independently represents a negatively charged ligand, wherein both Y ligands may optionally be joined to form a five- or six-membered platinocyclic ring; each L independently represents a neutral ligand, wherein both L ligands may optionally be joined to form a five- or six-membered platinocyclic ring; and R⁵ and R⁶ each independently represent an organic group, with the proviso that at least one of R⁵ and R⁶ includes a 1,3-dipole-functional group.

In some embodiments, each Y can independently represent a halide (e.g., Cl⁻, Br⁻, etc.), an alkoxide or aryloxide (e.g., RO⁻), a carboxylate (e.g., RC(O)O⁻), a sulfate (e.g., RSO₄⁻), or the like, wherein each R individually represents H or an organic group. In some embodiments, both Y ligands taken together represent a dianionic ligand such as a bidentate oxalate ligand.

In some embodiments, each L independently represents NR⁷R⁹₂, wherein each R⁷ and R⁹ independently represents H or an organic group, and wherein an R⁷ organic group from each L can optionally be joined to form a five- or six-membered platinocyclic ring.

In some embodiments, at least one of R⁵ and R⁶ represents the group —(CH₂)ₙ-G, wherein G represents a 1,3-dipole-functional group, and n=1 to 18.

In some embodiments, the 1,3-dipole-functional group is selected from the group consisting of an azide group, a nitrile oxide group, a nitrone group, an azoxy group, and combinations thereof.

An exemplary platinum(IV) compound can be of the formula:

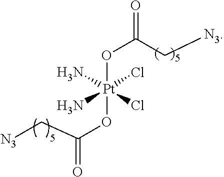

Another exemplary platinum(IV) compound can be of the formula:

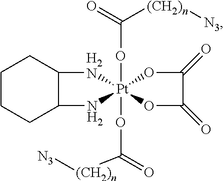

wherein each n is independently 1 to 18.

Another exemplary platinum(IV) compound can be of the formula:

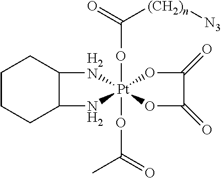

wherein n=1 to 18.

As used herein, the term “organic group” is used for the purpose of this invention to mean a hydrocarbon group that is classified as an aliphatic group, cyclic group, or combination of aliphatic and cyclic groups (e.g., alkaryl and aralkyl groups). In the context of the present invention, suitable organic groups for compounds of this invention are those that do not interfere with the reaction of an alkyne with a 1,3-dipole-functional compound to form a heterocyclic compound. In the context of the present invention, the term “aliphatic group” means a saturated or unsaturated linear or branched hydrocarbon group. This term is used to encompass alkyl, alkenyl, and alkynyl groups, for example. The term “alkyl group” means a saturated linear or branched monovalent hydrocarbon group including, for example, methyl, ethyl, n-propyl, isopropyl, tert-butyl, amyl, heptyl, and the like. The term “alkenyl group” means an unsaturated, linear or branched monovalent hydrocarbon group with one or more olefinically unsaturated groups (i.e., carbon-carbon double bonds), such as a vinyl group. The term “alkynyl group” means an unsaturated, linear or branched monovalent hydrocarbon group with one or more carbon-carbon triple bonds. The term “cyclic group” means a closed ring hydrocarbon group that is classified as an alicyclic group, aromatic group, or heterocyclic group. The term “alicyclic group” means a cyclic hydrocarbon group having properties resembling those of aliphatic groups. The term “aromatic group” or “aryl group” means a mono- or polynuclear aromatic hydrocarbon group. The term “heterocyclic group” means a closed ring hydrocarbon in which one or more of the atoms in the ring is an element other than carbon (e.g., nitrogen, oxygen, sulfur, etc.).

As a means of simplifying the discussion and the recitation of certain terminology used throughout this application, the terms “group” and “moiety” are used to differentiate between chemical species that allow for substitution or that may be substituted and those that do not so allow for substitution or may not be so substituted. Thus, when the term “group” is used to describe a chemical substituent, the described chemical material includes the unsubstituted group and that group with nonperoxidic O, N, S, Si, or F atoms, for example, in the chain as well as carbonyl groups or other conventional substituents. Where the term “moiety” is used to describe a chemical compound or substituent, only an unsubstituted chemical material is intended to be included. For example, the phrase “alkyl group” is intended to include not only pure open chain saturated hydrocarbon alkyl substituents, such as methyl, ethyl, propyl, tert-butyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc. On the other hand, the phrase “alkyl moiety” is limited to the inclusion of only pure open chain saturated hydrocarbon alkyl substituents, such as methyl, ethyl, propyl, tert-butyl, and the like.

A compound as described herein may contain one or more chiral centers and/or double bonds and, therefore, exist as stereoisomers, such as double-bond isomers (i.e., geometric isomers), enantiomers, or diastereomers. For purposes of the present disclosure, chemical structures depicted herein, including a compound according to Formula I, encompass all of the corresponding compounds' enantiomers, diastereomers and geometric isomers, that is, both the stereochemically pure form (e.g., geometrically pure, enantiomerically pure, or diastereomerically pure) and isomeric mixtures (e.g., enantiomeric, diastereomeric and geometric isomeric mixtures). In some cases, one enantiomer, diastereomer or geometric isomer will possess superior activity or an improved toxicity or kinetic profile compared to other isomers. In those cases, such enantiomers, diastereomers and geometric isomers of compounds of this invention are preferred.

When a disclosed compound is named or depicted by structure, it is to be understood that solvates (e.g., hydrates) of the compound or its pharmaceutically acceptable salts are also included. “Solvates” refer to crystalline forms wherein solvent molecules are incorporated into the crystal lattice during crystallization. Solvate may include water or nonaqueous solvents such as ethanol, isopropanol, DMSO, acetic acid, ethanolamine, and EtOAc. Solvates, wherein water is the solvent molecule incorporated into the crystal lattice, are typically referred to as “hydrates”. Hydrates include a stoichiometric or non-stoichiometric amount of water bound by non-covalent intermolecular forces.

When a disclosed compound is named or depicted by structure, it is to be understood that the compound, including solvates thereof, may exist in crystalline forms, non-crystalline forms or a mixture thereof. The compounds or solvates may also exhibit polymorphism (i.e. the capacity to occur in different crystalline forms). These different crystalline forms are typically known as “polymorphs.” It is to be understood that when named or depicted by structure, the disclosed compounds and solvates (e.g., hydrates) also include all polymorphs thereof. As used herein, the term “polymorph” means solid crystalline forms of a compound or complex thereof. Different polymorphs of the same compound can exhibit different physical, chemical and/or spectroscopic properties. Different physical properties include, but are not limited to stability (e.g., to heat or light), compressibility and density (important in formulation and product manufacturing), and dissolution rates (which can affect bioavailability). Differences in stability can result from changes in chemical reactivity (e.g., differential oxidation, such that a dosage form discolors more rapidly when comprised of one polymorph than when comprised of another polymorph) or mechanical characteristics (e.g., tablets crumble on storage as a kinetically favored polymorph converts to thermodynamically more stable polymorph) or both (e.g., tablets of one polymorph are more susceptible to breakdown at high humidity). Different physical properties of polymorphs can affect their processing. For example, one polymorph might be more likely to form solvates or might be more difficult to filter or wash free of impurities than another due to, for example, the shape or size distribution of particles of it. In addition, one polymorph may spontaneously convert to another polymorph under certain conditions.

When a disclosed compound is named or depicted by structure, it is to be understood that clathrates (“inclusion compounds”) of the compound or its pharmaceutically acceptable salts, solvates or polymorphs are also included. As used herein, the term “clathrate” means a compound of the present invention or a salt thereof in the form of a crystal lattice that contains spaces (e.g., channels) that have a guest molecule (e.g., a solvent or water) trapped within.

In some embodiments, the at least one cyclic alkyne is selected from the group consisting of cyclooctynes, monoarylcyclooctynes, and diarylcyclooctynes (e.g., a dibenzocyclooctyne).

In one embodiment, the at least one cyclic alkyne is of the formula:

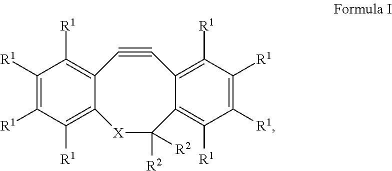

wherein: each R¹ is independently selected from the group consisting of hydrogen, halogen, hydroxy, alkoxy, nitrate, nitrite, sulfate, an organic group, a targeting group, an adjuvant, an antibody, a therapeutic, a dye, a sensor, a reporter, a biological polymer, a synthetic polymer, a particle, a vesicle, and an organic group attached to a surface; X represents C═O, C═N—OR³, C═N—NR³R⁴, CHOR³, CHNHR³, BR³, NR³, N(CO)R³, O, SiR³R⁴, PR³, O═PR³, or halogen; and each R², R³, and R⁴ is independently selected from the group consisting of hydrogen, an organic group, a targeting group, an adjuvant, an antibody, a therapeutic, a dye, a sensor, a reporter, a biological polymer, a synthetic polymer, a particle, a vesicle, and an organic group attached to a surface. In certain embodiments, each R¹ independently represents hydrogen or a C1-C10 organic group or moiety. In some certain embodiments, each R² represents hydrogen. See, for example, U.S. Pat. No. 8,133,515 B2 (Boons et al.) and U.S. Pat. No. 8,912,322 B2 (Popik et al.); U.S. Patent Application Publication No. 2013/0310570 A1 (Boons et al.); Debets et al., Chem. Commun. 2010, 46:97-99.

In another embodiment, the at least one cyclic alkyne is of the formula:

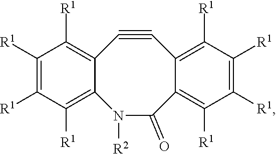

wherein: each R¹ and R² is independently selected from the group consisting of hydrogen, an organic group (a C1-C10 organic group or moiety), a targeting group, an adjuvant, an antibody, a therapeutic, a dye, a sensor, a reporter, a biological polymer, a synthetic polymer, a particle, a vesicle, and an organic group attached to a surface.

In another embodiment, the at least one cyclic alkyne is of the formula:

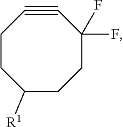

wherein R¹ is selected from the group consisting of hydrogen, an organic group (e.g. a C1-C10 organic group or moiety), a targeting group, an adjuvant, an antibody, a therapeutic, a dye, a sensor, a reporter, a biological polymer, a synthetic polymer, a particle, a vesicle, and an organic group attached to a surface. See, for example, Debets et al., Chem. Commun. 2010, 46:97-99; and Baskin et al., Proc. Natl. Acad. Sci. USA, 2007, 104:16793-16797.

In another embodiment, the at least one cyclic alkyne is of the formula:

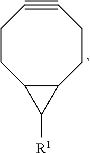

wherein R¹ is selected from the group consisting of hydrogen, an organic group (e.g. a C1-C10 organic group or moiety), a targeting group, an adjuvant, an antibody, a therapeutic, a dye, a sensor, a reporter, a biological polymer, a synthetic polymer, a particle, a vesicle, and an organic group attached to a surface.

In some embodiments, the 1,3-dipole-functional group is selected from the group consisting of an azide group, a nitrile oxide group, a nitrone group, an azoxy group, and combinations thereof.

One exemplary embodiment of a 1,3-dipole-functional compound is an azide-functional compound of the formula R⁸—N₃ (e.g., represented by the valence structure R⁸—⁻N—N═N¹), wherein R⁸ represents an organic group comprising a platinum(IV) compound.

The cyclization reaction of an azide-functional compound of the formula R⁸—N₃ with an exemplary alkyne of Formula I can result in one or more heterocyclic compounds of the formulas:

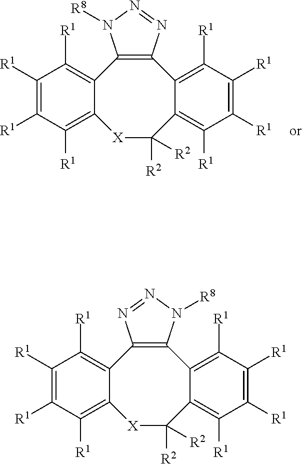

wherein: each R¹ is independently selected from the group consisting of hydrogen, halogen, hydroxy, alkoxy, nitrate, nitrite, sulfate, an organic group (e.g. a C1-C10 organic group or moiety), a targeting group, an adjuvant, an antibody, a therapeutic, a dye, a sensor, a reporter, a biological polymer, a synthetic polymer, a particle, a vesicle, and an organic group attached to a surface; X represents C═O, C═N—OR³, C═N—NR³R⁴, CHOR³, CHNHR³, BR³, NR³, N(CO)R³, O, SiR³R⁴, PR³, O═PR³, or halogen; each R², R³, and R⁴ is independently selected from the group consisting of hydrogen, an organic group (e.g. a C1-C10 organic group or moiety), a targeting group, an adjuvant, an antibody, a therapeutic, a dye, a sensor, a reporter, a biological polymer, a synthetic polymer, a particle, a vesicle, and an organic group attached to a surface; and R⁸ represents an organic group comprising a platinum(IV) compound.

Another exemplary embodiment of a 1,3-dipole-functional compound is a nitrile oxide-functional compound of the formula R⁸—CNO (e.g., represented by the valence structure R⁸—⁺C═N—O⁻), wherein R⁸ represents an organic group comprising a platinum(IV) compound.

The cyclization reaction of a nitrile oxide-functional compound of the formula R⁸—CNO with an exemplary alkyne of Formula I can result in one or more heterocyclic compounds of the formulas:

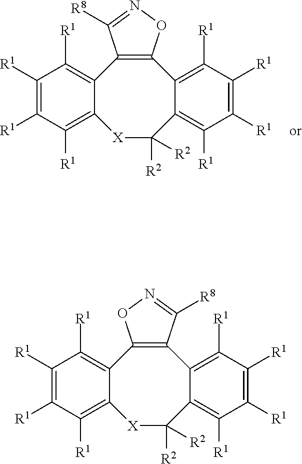

wherein: each R¹ is independently selected from the group consisting of hydrogen, halogen, hydroxy, alkoxy, nitrate, nitrite, sulfate, an organic group (e.g. a C1-C10 organic group or moiety), a targeting group, an adjuvant, an antibody, a therapeutic, a dye, a sensor, a reporter, a biological polymer, a synthetic polymer, a particle, a vesicle, and an organic group attached to a surface; X represents C═O, C═N—OR³, C═N—NR³R⁴, CHOR³, CHNHR³, BR³, NR³, N(CO)R³, O, SiR³R⁴, PR³, O═PR³, or halogen; each R², R³, and R⁴ is independently selected from the group consisting of hydrogen, an organic group (e.g. a C1-C10 organic group or moiety), a targeting group, an adjuvant, an antibody, a therapeutic, a dye, a sensor, a reporter, a biological polymer, a synthetic polymer, a particle, a vesicle, and an organic group attached to a surface; and R⁸ represents an organic group comprising a platinum(IV) compound.

Another exemplary embodiment of a 1,3-dipole-functional compound is a nitrone-functional compound of the formula (R¹⁰)₂CN(R¹⁰)O (e.g., represented by the valence structure (R¹⁰)₂C═⁺N(R¹⁰)—O⁻), wherein each R¹⁰ is independently selected from the group consisting of hydrogen, an organic group (e.g. a C1-C10 organic group or moiety), an organic group comprising a platinum(IV) compound; a targeting group, an adjuvant, an antibody, a therapeutic, a dye, a sensor, a reporter, a biological polymer, a synthetic polymer, a particle, a vesicle, and an organic group attached to a surface, with the proviso that at least one R¹⁰ represents an organic group comprising a platinum(IV) compound.

The cyclization reaction of a nitrone-functional compound of the formula (R¹⁰)²CN(R¹⁰)O with an exemplary alkyne of Formula I can result in one or more heterocyclic compounds of the formulas:

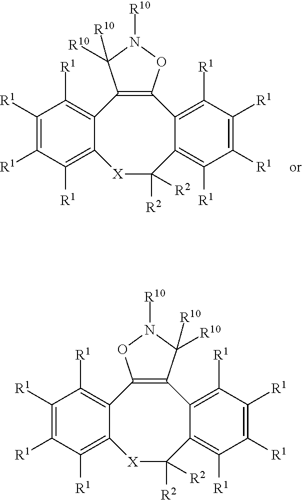

wherein: each R¹ is independently selected from the group consisting of hydrogen, halogen, hydroxy, alkoxy, nitrate, nitrite, sulfate, an organic group (e.g. a C1-C10 organic group or moiety), a targeting group, an adjuvant, an antibody, a therapeutic, a dye, a sensor, a reporter, a biological polymer, a synthetic polymer, a particle, a vesicle, and an organic group attached to a surface; X represents C═O, C═N—OR³, C═N—NR³R⁴, CHOR³, CHNHR³, BR³, NR³, N(CO)R³, O, SiR³R⁴, PR³, O═PR³, or halogen; each R², R³, and R⁴ is independently selected from the group consisting of hydrogen, an organic group (e.g. a C1-C10 organic group or moiety), a targeting group, an adjuvant, an antibody, a therapeutic, a dye, a sensor, a reporter, a biological polymer, a synthetic polymer, a particle, a vesicle, and an organic group attached to a surface; and each R¹⁰ is independently selected from the group consisting of hydrogen, an organic group (e.g. a C1-C10 organic group or moiety), an organic group comprising a platinum(IV) compound; a targeting group, an adjuvant, an antibody, a therapeutic, a dye, a sensor, a reporter, a biological polymer, a synthetic polymer, a particle, a vesicle, and an organic group attached to a surface, with the proviso that at least one R¹⁰ represents an organic group comprising a platinum(IV) compound.

Another exemplary embodiment of a 1,3-dipole-functional compound is an azoxy-functional compound of the formula R¹⁰—NN(R¹⁰)O (e.g., represented by the valence structure)R¹⁰—N═⁺N(R¹⁰)—O⁻), wherein each R¹⁰ is independently selected from the group consisting of hydrogen, an organic group (e.g. a C1-C10 organic group or moiety), an organic group comprising a platinum(IV) compound; a targeting group, an adjuvant, an antibody, a therapeutic, a dye, a sensor, a reporter, a biological polymer, a synthetic polymer, a particle, a vesicle, and an organic group attached to a surface, with the proviso that at least one R¹⁰ represents an organic group comprising a platinum(IV) compound.

The cyclization reaction of an azoxy-functional compound of the formula R¹⁰—NN(R¹⁰)O with an exemplary alkyne of Formula I can result in one or more heterocyclic compounds of the formulas:

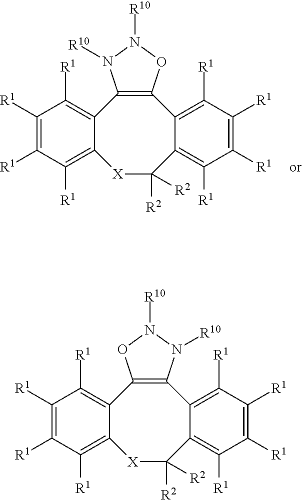

wherein: each R¹ is independently selected from the group consisting of hydrogen, halogen, hydroxy, alkoxy, nitrate, nitrite, sulfate, an organic group (e.g. a C1-C10 organic group or moiety), a targeting group, an adjuvant, an antibody, a therapeutic, a dye, a sensor, a reporter, a biological polymer, a synthetic polymer, a particle, a vesicle, and an organic group attached to a surface; X represents C═O, C═N—OR³, C═N—NR³R⁴, CHOR³, CHNHR³, BR³, NR³, N(CO)R³, O, SiR³R⁴, PR³, O═PR³, or halogen; each R², R³, and R⁴ is independently selected from the group consisting of hydrogen, an organic group (e.g. a C1-C10 organic group or moiety), a targeting group, an adjuvant, an antibody, a therapeutic, a dye, a sensor, a reporter, a biological polymer, a synthetic polymer, a particle, a vesicle, and an organic group attached to a surface; and each R¹⁰ is independently selected from the group consisting of hydrogen, an organic group (e.g. a C1-C10 organic group or moiety), an organic group comprising a platinum(IV) compound; a targeting group, an adjuvant, an antibody, a therapeutic, a dye, a sensor, a reporter, a biological polymer, a synthetic polymer, a particle, a vesicle, and an organic group attached to a surface, with the proviso that at least one R¹⁰ represents an organic group comprising a platinum(IV) compound.

In some embodiments, the conditions effective for a cycloaddition reaction to form the one or more heterocyclic compounds include the substantial absence of added catalyst.

In another aspect, the present disclosure provides heterocyclic compounds that include a platinum(IV) compound.

In some embodiments, the heterocyclic compounds can be prepared by methods discussed herein above. In addition to the exemplary heterocyclic compounds disclosed herein above, additional exemplary heterocyclic compounds that can be prepared from alternative cyclic alkynes (e.g., as disclosed herein above) are disclosed herein below.

In another embodiment, an exemplary heterocyclic compound can be of the formula:

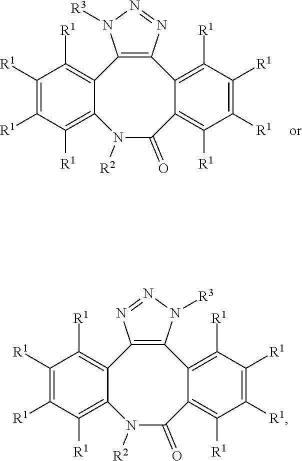

wherein: each R¹ and R² is independently selected from the group consisting of hydrogen, an organic group (e.g. a C1-C10 organic group or moiety), a targeting group, an adjuvant, an antibody, a therapeutic, a dye, a sensor, a reporter, a biological polymer, a synthetic polymer, a particle, a vesicle, and an organic group attached to a surface; and R³ represents an organic group including a platinum(IV) compound.

In another embodiment, an exemplary heterocyclic compound can be of the formula:

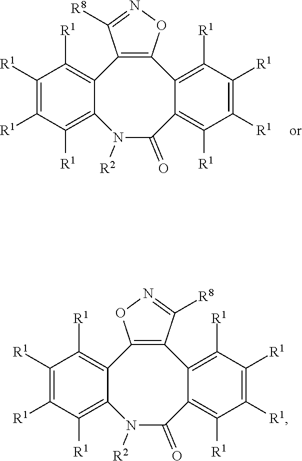

wherein: each R¹ and R² is independently selected from the group consisting of hydrogen, an organic group (e.g. a C1-C10 organic group or moiety), a targeting group, an adjuvant, an antibody, a therapeutic, a dye, a sensor, a reporter, a biological polymer, a synthetic polymer, a particle, a vesicle, and an organic group attached to a surface; and R⁸ represents an organic group including a platinum(IV) compound.

In another embodiment, an exemplary heterocyclic compound can be of the formula:

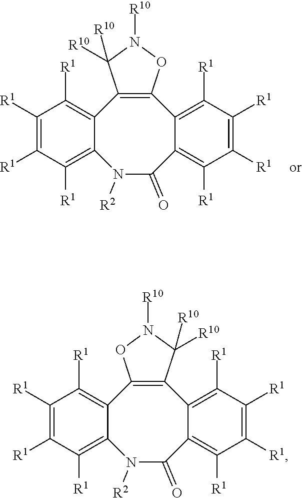

wherein: each R¹ and R² is independently selected from the group consisting of hydrogen, an organic group (e.g. a C1-C10 organic group or moiety), a targeting group, an adjuvant, an antibody, a therapeutic, a dye, a sensor, a reporter, a biological polymer, a synthetic polymer, a particle, a vesicle, and an organic group attached to a surface; and each R¹⁰ is independently selected from the group consisting of hydrogen, an organic group (e.g. a C1-C10 organic group or moiety), an organic group including a platinum(IV) compound; a targeting group, an adjuvant, an antibody, a therapeutic, a dye, a sensor, a reporter, a biological polymer, a synthetic polymer, a particle, a vesicle, and an organic group attached to a surface, with the proviso that at least one R¹⁰ represents an organic group including a platinum(IV) compound.

In another embodiment, an exemplary heterocyclic compound can be of the formula:

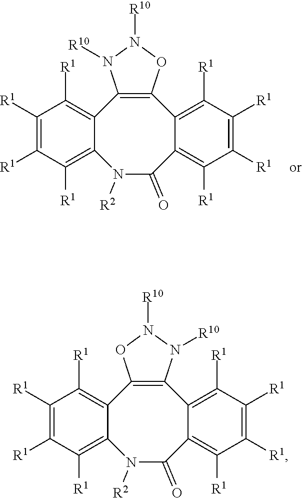

wherein: each R¹ and R² is independently selected from the group consisting of hydrogen, an organic group (e.g. a C1-C10 organic group or moiety), a targeting group, an adjuvant, an antibody, a therapeutic, a dye, a sensor, a reporter, a biological polymer, a synthetic polymer, a particle, a vesicle, and an organic group attached to a surface; and each R¹⁰ is independently selected from the group consisting of hydrogen, an organic group (e.g. a C1-C10 organic group or moiety), an organic group including a platinum(IV) compound; a targeting group, an adjuvant, an antibody, a therapeutic, a dye, a sensor, a reporter, a biological polymer, a synthetic polymer, a particle, a vesicle, and an organic group attached to a surface, with the proviso that at least one R¹⁰ represents an organic group including a platinum(IV) compound.

In another embodiment, an exemplary heterocyclic compound can be of the formula:

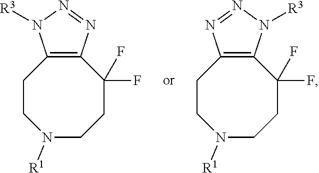

wherein: R¹ is selected from the group consisting of hydrogen, an organic group (e.g. a C1-C10 organic group or moiety), a targeting group, an adjuvant, an antibody, a therapeutic, a dye, a sensor, a reporter, a biological polymer, a synthetic polymer, a particle, a vesicle, and an organic group attached to a surface; and R³ represents an organic group including a platinum(IV) compound.

In another embodiment, an exemplary heterocyclic compound can be of the formula:

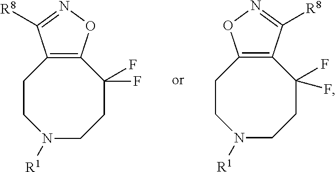

wherein: R¹ is selected from the group consisting of hydrogen, an organic group (e.g. a C1-C10 organic group or moiety), a targeting group, an adjuvant, an antibody, a therapeutic, a dye, a sensor, a reporter, a biological polymer, a synthetic polymer, a particle, a vesicle, and an organic group attached to a surface; and R⁸ represents an organic group including a platinum(IV) compound.

In another embodiment, an exemplary heterocyclic compound can be of the formula:

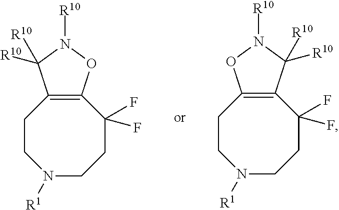

wherein: R¹ is selected from the group consisting of hydrogen, an organic group (e.g. a C1-C10 organic group or moiety), a targeting group, an adjuvant, an antibody, a therapeutic, a dye, a sensor, a reporter, a biological polymer, a synthetic polymer, a particle, a vesicle, and an organic group attached to a surface; and each R¹⁰ is independently selected from the group consisting of hydrogen, an organic group (e.g. a C1-C10 organic group or moiety), an organic group including a platinum(IV) compound; a targeting group, an adjuvant, an antibody, a therapeutic, a dye, a sensor, a reporter, a biological polymer, a synthetic polymer, a particle, a vesicle, and an organic group attached to a surface, with the proviso that at least one R¹⁰ represents an organic group including a platinum(IV) compound.

In another embodiment, an exemplary heterocyclic compound can be of the formula:

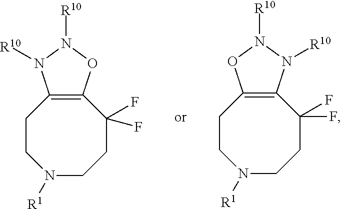

wherein: R¹ is selected from the group consisting of hydrogen, an organic group (e.g. a C1-C10 organic group or moiety), a targeting group, an adjuvant, an antibody, a therapeutic, a dye, a sensor, a reporter, a biological polymer, a synthetic polymer, a particle, a vesicle, and an organic group attached to a surface; and each R¹⁰ is independently selected from the group consisting of hydrogen, an organic group (e.g. a C1-C10 organic group or moiety), an organic group including a platinum(IV) compound; a targeting group, an adjuvant, an antibody, a therapeutic, a dye, a sensor, a reporter, a biological polymer, a synthetic polymer, a particle, a vesicle, and an organic group attached to a surface, with the proviso that at least one R¹⁰ represents an organic group including a platinum(IV) compound.

In another embodiment, an exemplary heterocyclic compound can be of the formula:

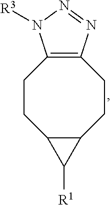

wherein: R¹ is selected from the group consisting of hydrogen, an organic group (e.g. a C1-C10 organic group or moiety), a targeting group, an adjuvant, an antibody, a therapeutic, a dye, a sensor, a reporter, a biological polymer, a synthetic polymer, a particle, a vesicle, and an organic group attached to a surface; and R³ represents an organic group including a platinum(IV) compound.

In another embodiment, an exemplary heterocyclic compound can be of the formula:

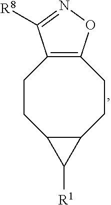

wherein: R¹ is selected from the group consisting of hydrogen, an organic group (e.g. a C1-C10 organic group or moiety), a targeting group, an adjuvant, an antibody, a therapeutic, a dye, a sensor, a reporter, a biological polymer, a synthetic polymer, a particle, a vesicle, and an organic group attached to a surface; and R⁸ represents an organic group including a platinum(IV) compound.

In another embodiment, an exemplary heterocyclic compound can be of the formula:

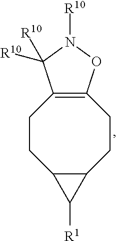

wherein: R¹ is selected from the group consisting of hydrogen, an organic group (e.g. a C1-C10 organic group or moiety), a targeting group, an adjuvant, an antibody, a therapeutic, a dye, a sensor, a reporter, a biological polymer, a synthetic polymer, a particle, a vesicle, and an organic group attached to a surface; and each R¹⁰ is independently selected from the group consisting of hydrogen, an organic group (e.g. a C1-C10 organic group or moiety), an organic group including a platinum(IV) compound; a targeting group, an adjuvant, an antibody, a therapeutic, a dye, a sensor, a reporter, a biological polymer, a synthetic polymer, a particle, a vesicle, and an organic group attached to a surface, with the proviso that at least one R¹⁰ represents an organic group including a platinum(IV) compound.

In another embodiment, an exemplary heterocyclic compound can be of the formula:

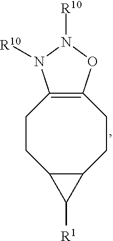

wherein: R¹ is selected from the group consisting of hydrogen, an organic group (e.g. a C1-C10 organic group or moiety), a targeting group, an adjuvant, an antibody, a therapeutic, a dye, a sensor, a reporter, a biological polymer, a synthetic polymer, a particle, a vesicle, and an organic group attached to a surface; and each R¹⁰ is independently selected from the group consisting of hydrogen, an organic group (e.g. a C1-C10 organic group or moiety), an organic group including a platinum(IV) compound; a targeting group, an adjuvant, an antibody, a therapeutic, a dye, a sensor, a reporter, a biological polymer, a synthetic polymer, a particle, a vesicle, and an organic group attached to a surface, with the proviso that at least one R¹⁰ represents an organic group including a platinum(IV) compound.

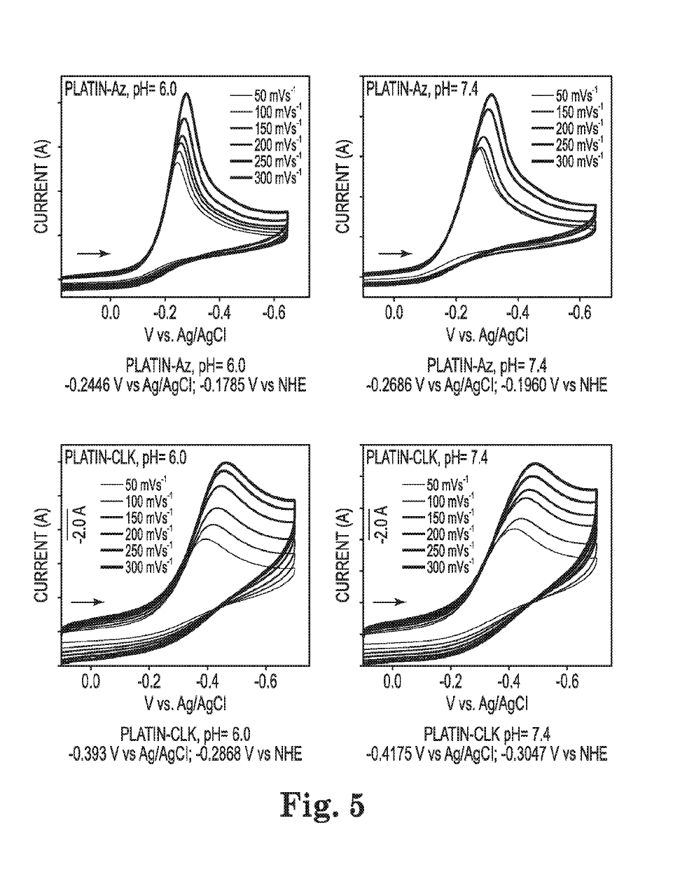

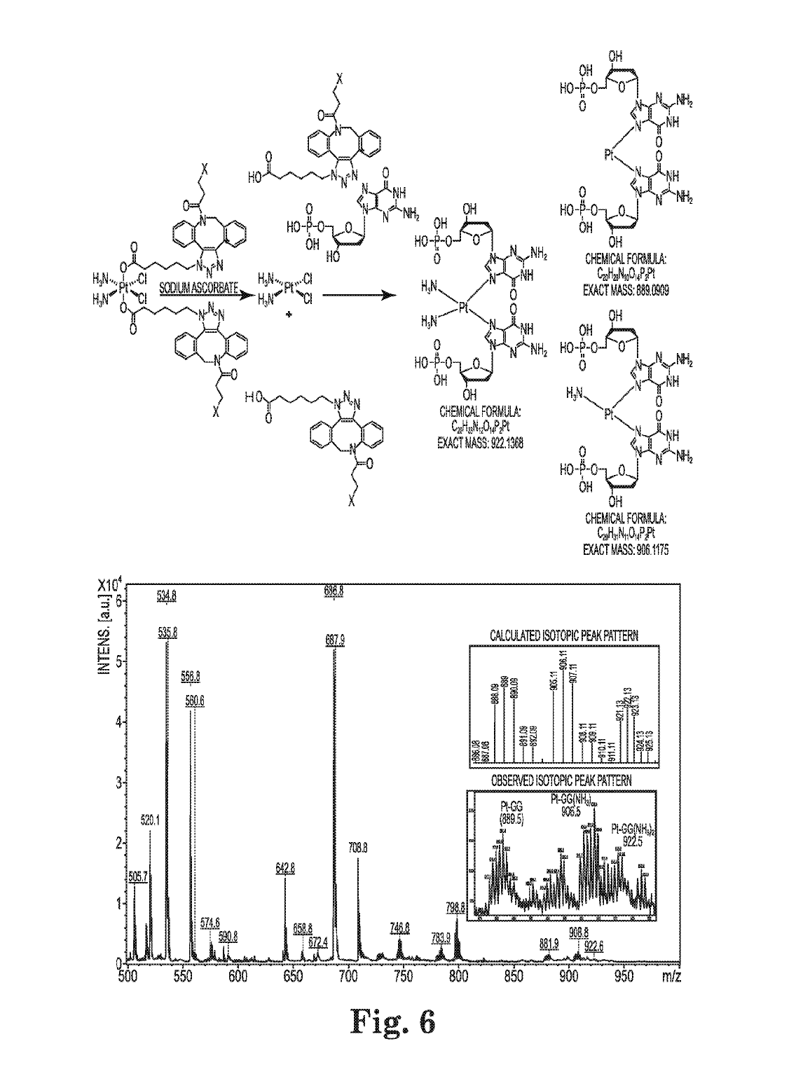

ADIBO-based click chemistry probes are excellent for introducing new functionalities and to increase lipophilic properties of molecules of interest for their biological activities (e.g., Kuzmin et al., Bioconjug. Chem. 2010, 21:2076). A new terminal azide Pt(IV) compound, Platin-Az was synthesized (FIG. 2) as a precursor which can be used in a variety of SPAAC with functionalized ADIBO-X (FIG. 1). To demonstrate the effectiveness of this platform, an acid functionalized ADIBO-COOH was synthesized by reacting ADIBO-NH₂ with succinic anhydride (FIG. 2). Reaction of Platin-Az with ADIBO-COOH resulted in Platin-CLK in an efficient manner (FIG. 2). The success in performing SPAAC reaction on Pt(IV) prodrug indicated that this technology in conjunction with Platin-Az can be used to introduce numerous functionalities when one uses suitably functionalized ADIBO derivatives for incorporation of another therapeutic, targeting moiety, fluorescent reporter, a dye, a sensor, etc. A comparison of redox potentials of Platin-Az and Platin-CLK at two different pH values of 6.0 and 7.4 demonstrated that introduction of ADIBO functionality does not change the redox behavior of the prodrug; favorable redox parameters required for cellular reduction to cisplatin were noted (FIG. 5). DNA binding ability of cisplatin produced upon reduction of Platin-CLK was studied by performing reduction with sodium ascorbate followed by reaction with 2′-deoxyguanosine 5′-monophosphate sodium salt hydrate (5′-GMP) as a truncated version of DNA. Product analysis by matrix-assisted laser desorption/ionization (MALDI)-time of flight (TOF)-mass spectrometry (MS) confirmed the presence of Pt^{II}-5′-GMP-bisadduct, [Pt(NH3)2(5′-GMP-N7)2] (m/z=922, FIG. 6).

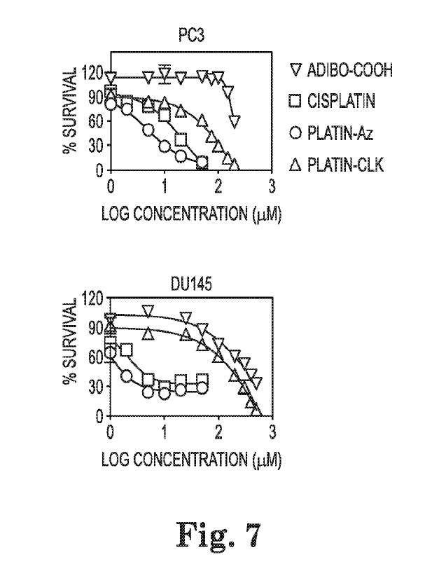

The anti-proliferative properties of these new Pt(IV) complexes, Platin-Az and Platin-CLK were tested in prostate cancer (PCa) PC3 and DU145 cell lines. Cisplatin and ADIBO-COOH were used as controls. Incubation of different concentrations of these complexes with PC3 and DU145 cells for 72 hours followed by cell survival analyses using 3-(4,5-dimethylthiazol-2-yl)-2,5-diphenyltetrazolium bromide (MTT) assay demonstrated that these complexes show efficient cell killing behavior as shown in Table 1 (see also, FIG. 7).

TABLE 1
Size, Polydispersity Index (PDI), and Zeta Potentials of NPs

| Platin-CLK Feed | | | |
|---|---|---|---|
| (% Wt with respect | Hydrodynamic | | Zeta |
| to polymer) | diameter (nm) | PDI | Potential (mV) |
| 0% | 134.8 ± 5.3 | 0.203 | −24.1 ± 1.2 |
| 5% | 106.5 ± 8.2 | 0.267 | −15.2 ± 1.4 |
| 10% | 136.0 ± 4.5 | 0.240 | −18.4 ± 2.2 |
| 20% | 139.8 ± 3.1 | 0.237 | −19.9 ± 0.5 |
| 30% | 130.9 ± 13.2 | 0.199 | −19.6 ± 1.4 |
| 40% | 136.6 ± 4.7 | 0.280 | −20.5 ± 0.9 |
| 50% | 147.0 ± 4.1 | 0.259 | −18.6 ± 1.4 |

The high IC50 values of ADIBO-COOH indicated that this precursor can be used to introduce variety of functionalities on platinum center.

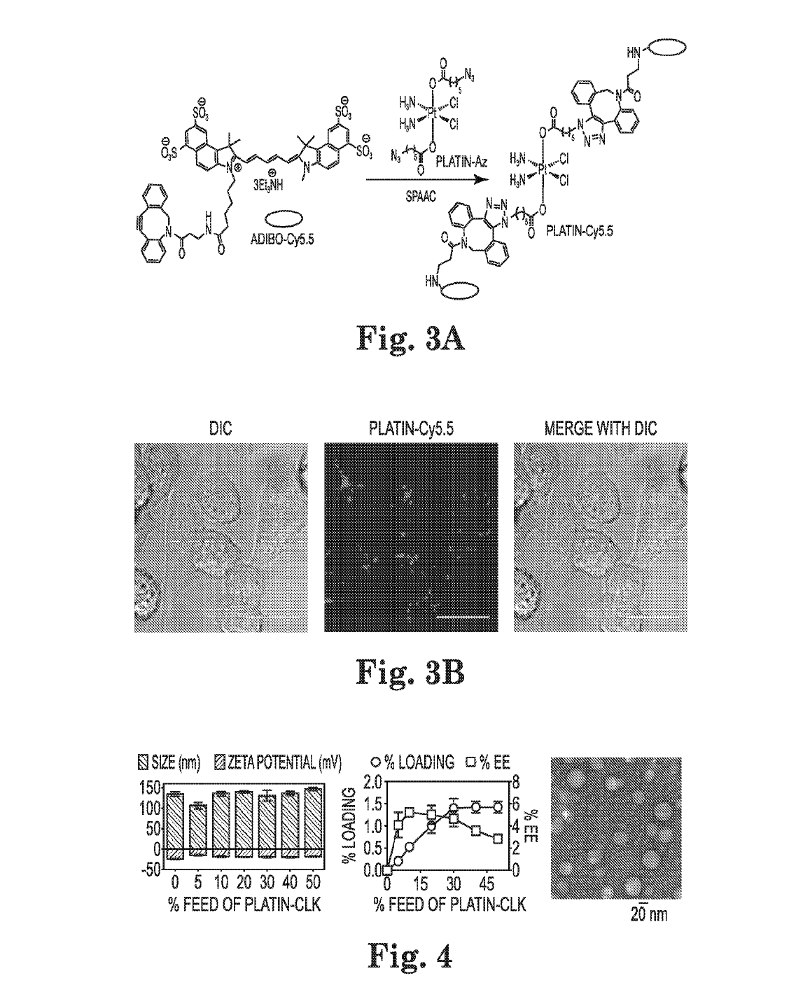

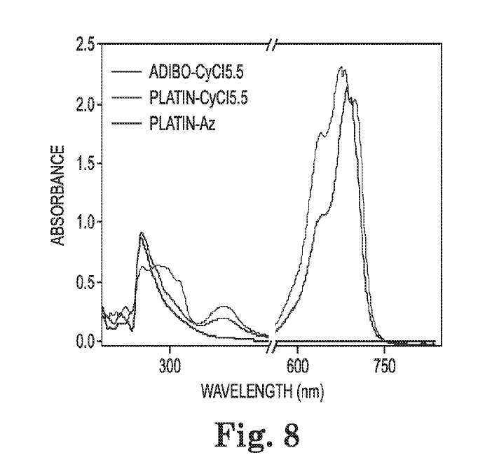

The ability to install a robust near-infrared fluorescent reporter such as Cy5.5 in Platin-Az using SPAAC was investigated. A Cy5.5-functionalized ADIBO derivative, ADIBO-Cy5.5, was used to construct Platin-Cy5.5 from Platin-Az (FIGS. 3A and 8). This construct was used to understand the cellular uptake of this series of Pt(IV) prodrugs by performing live cell imaging in PC3 cells (FIG. 3B). Confocal microscopy analysis of the treated cells indicated significant uptake of Platin-Cy5.5 inside the cells demonstrated the ability to install cell reporters in this platform.

Clinical translation of small molecule-based therapies face tremendous challenges due to their poor biodistribution (bioD) and pharmacokinetic (PK) properties, rapid clearance, and marked toxicity. Because of their large size compared to small molecules, nanoparticles (NPs) hold promise as carriers of small molecules. Biodegradable poly(D,L-lactic-co-glycolic acid)-block (PLGA-b)-poly(ethylene glycol) (PEG)-based polymeric NPs can be used as delivery vehicles for Pt(IV)-based compounds (e.g., Dhar et al., Proc. Natl. Acad. Sci. U.S.A. 2008, 105:17356). However, successful engineering of polymeric NPs loaded with Pt(IV) compounds primarily depends on the hydrophilicity/hydrophobicity of the molecule of interest. Most Pt(IV) compounds show very low loadings without compromising suitable NP sizes required for tumor accumulation (e.g., Dhar et al., Proc. Natl. Acad. Sci. U.S.A. 2008, 105:17356; Graf et al., ACS Nano 2012, 6:4530; and Johnstone et al., Inorg. Chem. 2013, 52:9915). See, also, PCT/US2014/069997, with an International Filing Date of Dec. 12, 2014; and U.S. Provisional Application No. 61/976,559, filed Apr. 8, 2014.

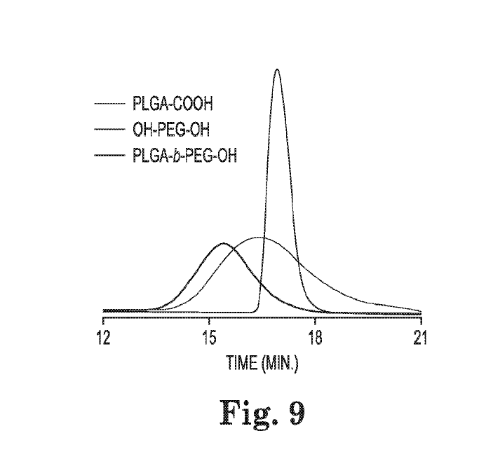

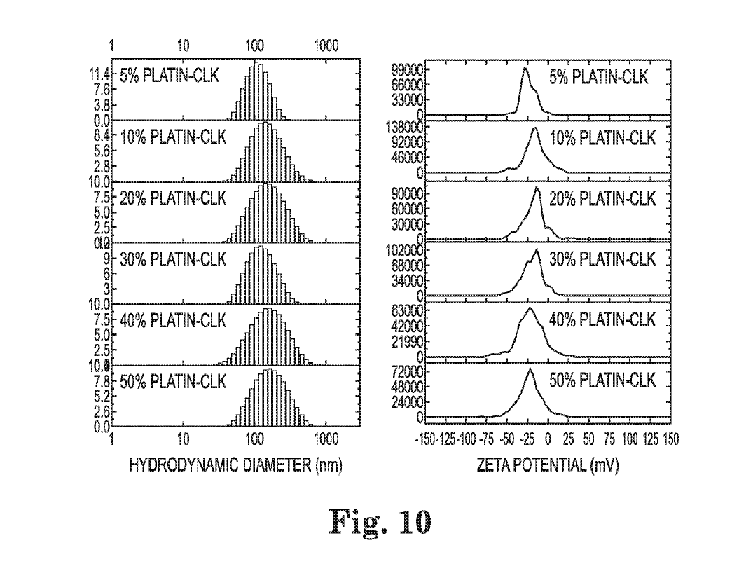

We investigated the ability of Platin-CLK-based prodrugs to be encapsulated in PLGA-b-PEG-based NPs. The interior of PLGA-b-PEG-NPs is more hydrophobic than their surface and presence of hydrophobic moieties on ADIBO increased the lipophilic character of Platin-CLK making it convenient for NP-based delivery approaches to manage PK and bioD properties of such Pt complexes. PLGA-COOH and OH-PEG-OH polymers were used to prepare PLGA-b-PEG-OH copolymer (FIG. 9) (e.g., Marrache et al., Proc. Natl. Acad. Sci. U.S.A. 2012, 109:16288). We used a nanoprecipitation method to encapsulate Platin-CLK and the NPs were characterized by dynamic light scattering (DLS) to give the size, polydispersity, and zeta potential of each preparation as shown in Table 2 (see also FIGS. 4 and 10).

TABLE 2
IC₅₀ Values in Prostate Cancer Cells

IC₅₀ (μM)

| | PC3 | DU145 |
|---|---|---|
| ADIBO-COOH | >200 | 284 ± 72 |
| Cisplatin | 12 ± 2 | 6.0 ± 0.9 |
| Platin-Az | 4.5 ± 0.3 | 2.0 ± 0.2 |
| Platin-CLK | 61 ± 10 | 43 ± 5 |

Morphology of these NPs was checked using transmission electron microscopy (TEM) (FIG. 4). The loading and encapsulation efficiency (EE) of Platin-CLK at various added weight-percentage values of Pt(IV) to polymer are shown in FIG. 4. The ability to load Platin-CLK inside PLGA-b-PEG-NPs without compromising the size of the NPs further demonstrated the usefulness of this platform (FIG. 4).

As described herein, we developed a platform technology for construction of Pt(IV) complexes containing functionalities such as cell receptor targeting moiety, a delivery system, other therapeutics, or fluorescent reporters with easiness and high efficacy. A versatile Pt(IV) prodrug Platin-Az was synthesized to use as an universal precursor in SPAAC reaction. Using this precursor, we demonstrated the utility of Cu(I) free SPAAC reaction in presence of ADIBO-X to introduce new functionalities with easiness and high efficacy. We demonstrated the ability of these complexes to be encapsulated in hydrophobic core of PLGA-b-PEG-based NPs. Unique ability of this platform for easy installation of a cell reporter such as fluorescent Cy5.5 was demonstrated for tracking Pt(IV) prodrugs in live cells. These new Pt(IV) compounds demonstrated favorable redox and anti-proliferative properties. The modular designing of this platform and the huge scope to introduce multiple functionalities with high efficiency using synthetic chemistry make this work a key platform in discovering new platinum-based therapeutic agents.

The present invention is illustrated by the following examples. It is to be understood that the particular examples, materials, amounts, and procedures are to be interpreted broadly in accordance with the scope and spirit of the invention as set forth herein.

### EXAMPLES

### Materials and Instrumentations.

All chemicals were received and used without further purification unless otherwise noted. Dimethylaminopyridine (DMAP), K2PtCl4, 2′-deoxyguanosine 5′-monophosphate sodium salt hydrate (5′-GMP), sodium ascorbate, KCl, N-hydroxysuccinamide, triethylamine, 6-bromohexanoic acid, succinic anhydride, sodium azide, N,N′-dicyclohexylcarbodiimide (DCC), hydrogen peroxide solution (30 wt % in H₂O), (3-(4,5-dimethylthiazol-2-yl)-2,5-diphenyltetrazolium bromide (MTT) were purchased from Sigma-Aldrich. Cisdiamminedichloridoplatinum(II) or cisplatin was procured from Sterm Chemicals, Inc. Carboxy terminated PLGA-COOH (dL/g, 0.15 to 0.25) was procured from Lactel and OH-PEG-OH of molecular weight 3350 was purchased from Sigma Aldrich. ADIBO-Cy5.5 (Product number, 1046) was purchased from Click Chemistry Tools Bioconjugate Technology Company.

Distilled water was purified by passage through a Millipore Milli-Q Biocel water purification system (18.2 MΩ) containing a 0.22 μm filter. ¹H and ¹³C spectra were recorded on a 400 MHz and ¹⁹⁵Pt NMR spectra recorded on a 500 MHz Varian NMR spectrometer, respectively. Electrospray ionization mass spectrometry (ESI-MS) and high-resolution mass spectrometry (HRMS)-ESI were recorded on Perkin Elmer SCIEX API 1 plus and Thermo scientific ORBITRAP ELITE instruments, respectively. Electrochemical measurements were made at 25° C. on an analytical system model CHI 920c potentiostat from CH Instruments, Inc. (Austin, Tex.). Cells were counted using an Automated Cell Counter available under the trade designation COUNTESS from Invitrogen life technology. Dynamic light scattering (DLS) measurements were carried out using a Malvern Zetasizer Nano ZS system. Optical measurements were carried out on a NanoDrop 2000 spectrophotometer. Transmission electron microscopy (TEM) images were acquired using a Philips/FEI Technai 20 microscope. Confocal images were recorded in a Nikon Al confocal microscope. Inductively coupled plasma mass spectrometry (ICP-MS) studies were performed on a VG PlasmaQuad 3 ICP mass spectrometer. Plate reader analyses were performed on a Bio-Tek Synergy HT microplate reader. Gel permeation chromatographic (GPC) analyses were performed on Shimadzu LC20-AD prominence liquid chromatographer equipped with a refractive index (RI) detector; molecular weights were calculated using a conventional calibration curve constructed from narrow polystyrene standards.

Cell Lines and Cell Culture. Human prostate cancer cell lines, PC3 and DU145 were procured from the American type culture collection (ATCC) and grown in Roswell Park Memorial Institute (RPMI) 1640 medium supplemented with 10% fetal bovine serum (FBS) and 1% penicillin/streptomycin. Cells were passed every 3 to 4 days and restarted from frozen stocks upon reaching pass number 20.

Synthesis of 6-azidohexanoic acid. A solution of 6-bromohexanoic acid (5.0 g, 25 5 mmol) in 40 mL of dimethyl sulfoxide (DMSO) was heated to 40° C. and NaN₃ (8.29 g, 127.55 mmol) was added in a stepwise manner. The reaction mixture was heated to 80° C. and stirred for 12 hours. The temperature was decreased to 40° C. and concentrated HCl (11 mL) was added stepwise to this reaction mixture and stirred for 12 hours. The product was purified by extraction with diethyl ether (5×50 mL). The ether layers were collected, washed with 10% aqueous NaHSO₄ (2×50 mL) and water (3×50 mL), dried over MgSO₄, filtered, and the solvent was evaporated to get a light yellow color oil as the product. Yield, 4.0 g (quantitative). ¹H NMR (400 MHz, CDCl₃): δ 10.02 (broad s, 1H), 3.21 (t, 2H), 2.33 (t, 2H), 1.40 (m, 4 H), 1.36 (t, 2H) ppm. ¹³C NMR (100 MHz, CDCl₃): δ 179.84, 51.16, 33.81, 28.51, 26.12, 24.12 ppm.

Synthesis of 6-azidohexanoic anhydride. A suspension of 6-azidohexanoic acid (1.0 g, 6 3 mmol) in 30 mL of CH₂Cl₂ was prepared and a solution of DCC (653 mg, 3.2 mmol) in 10 mL of CH₂Cl₂ was added. The reaction mixture was stirred at room temperature for 12 hours. The urea by product dicyclohexylurea (DCU) was filtered off using a glass filter and washed with a small amount of CH₂Cl₂. The solvent was evaporated and the resulting residue was taken up in ethyl acetate. Residual DCU was removed by filtering a suspension through a glass filter. The filtrate was evaporated to give the anhydride as a viscous oil with a quantitative yield. The anhydride was used directly for the next reaction.

Synthesis of ADIBO-COOH. Succinic anhydride (0.21 g, 2 1 mmol) was added to a solution of ADIBO-amine (0.44 g, 1.59 mmol) and triethylamine (0.4 mL, 3.2 mmol) in chloroform (30 mL). The reaction mixture was stirred for 4 hours, concentrated in vacuo, and purified by silica gel chromatography (CH₂Cl₂/MeOH: 20:1) to afford ADIBO-COOH (0.5 g, 83% yield) as an off white crystal. ¹H NMR: δ 7.65-7.67 (d, J=7.67 Hz, 1H), 7.27-7.40 (m, 7H), 6.54 (bs, 1H), 5.11-5.15 (d, J=13.9 Hz, 1H), 3.69-3.73 (d, J=13.9 Hz, 1H), 3.34-3.41 (m, 1H), 3.15-3.21 (m, 1H), 2.56-2.66 (m, 2H), 2.44-2.51 (m, 1H), 2.28-2.39 (m, 2H), 1.94-2.01 (m, 1H) ppm. ¹³C-NMR: δ 175.68, 172.62, 172.32, 151.12, 148.01, 132.36, 129.23, 128.89, 128.76, 128.54, 128.13, 127.48, 125.82, 123.12, 122.75, 115.05, 107.91, 55.86, 35.72, 34.69, 30.86, 30.04, 34.5 ppm. ESI HRMS: calcd. (M+H⁺): C₂₂H₂₀N₂O₄: 377.1495, found: 377.1492.

Synthesis of Platin-Az. A mixture of c,c,t [PtCl₂(NH₃)₂(OH)₂] (0.54 g, 1.60 mmol) and 6-azidohexanoic anhydride (1.7 g, 5 6 mmol) in DMSO (5 mL) was stirred for 24 hours. The solvent was then removed by multiple diethyl ether wash. The crude product was purified by dissolving in acetonitrile and precipitated with diethyl ether to get a light yellow solid. Yield 0.63 g (64%). ¹H NMR (400 MHz, CDCl₃): δ 6.53 (m, 6H), 3.30 (t, 2H), 2.22 (t, 2H), 1.32-1.50 (m, 6H) ppm. ¹³C NMR (100 MHz, CDCl₃): δ 181.13, 51.02, 35.92, 28.43, 26.15, 25.37 ppm. ¹⁹⁵Pt (DMSO-d6, 107.6 MHz): δ ppm 1215.33. HRMS m/z Calcd. For C₁₂H₂₇Cl₂N₈O₄Pt: (M+H)⁺ 612.1180. Found 612.1159.

Synthesis of Platin-CLK. A solution of Platin-Az (80 mg, 0.13 mmol) and ADIBO-COOH (103 mg, 0.27 mmol) in 5 mL of dry dimethylformamide (DMF) was stirred at room temperature for 12 hours. The solvent was evaporated under reduced pressure. The temperature during rotavap was kept below 40° C. The crude product was suspended in CH₂Cl₂ and acetonitrile (1:2) and precipitated with diethyl ether (6×). Finally the product was isolated by precipitating with CH₂Cl₂:diethyl ether (2:8) to get an off white solid. Yield, 141 mg, 79%. ¹H NMR (DMSO-d6, 400 MHz): δ 12.05 (broad s, 1H), 7.25-7.73 (m, 18H), 6.53 (broad, 6H), 5.84-5.97 (m, 2H), 4.37-4.44 (m, 2H), 4.16-4.22 (m, 4H), 2.97 (t, 4H), 2.86 (m, 2H), 2.33 (t, 4H), 2.18 (m, 8H), 1.82-1.93 (m, 4H), 1.31-1.57 (m, 8H), 0.99-1.11 (m, 2H) ppm. ¹³C NMR (DMSO-d6, 100 MHz): δ 181.12, 174.29, 171.40, 169.76, 144.18, 142.63, 141.37, 140.47, 135.81, 134.27, 132.02, 131.17, 129.60, 129.12, 128.69, 127.87, 127.32, 124.71, 52.27, 50.93, 48.90, 48.18, 35.55, 33.78, 30.29, 29.46, 28.46, 26.27, 25.55 ppm. ¹⁹⁵Pt (DMSO-d6, 107.6 MHz): δ 1213.97 ppm. HRMS m/z Calcd. for C₅₆H₆₇Cl₂N₁₂O₁₂Pt: (M+H⁺) 1364.4026. Found 1364.4027.

Electrochemical Measurements Using Cyclic Voltammetry. Electrochemical measurements were made at 25° C. on an analytical system model CHI 920c potentiostat from CH Instruments, Inc. (Austin, Tex.). A conventional three-electrode set-up comprising a glassy carbon working electrode, platinum wire auxiliary electrode, and an Ag/AgCl (3M KCl) reference electrode was used for electrochemical measurements. The electrochemical data were uncorrected for junction potentials. KCl was used as a supporting electrolyte. Platin-Az and Platin-CLK (1 mM) solutions were prepared in 20% DMF-phosphate buffered saline (PBS) of pH 6.0 and 7.4 with 1 mM KCl and voltammograms were recorded at different scan rates (FIG. 5).

Determination of Pt-GG Adduct Formation. Platin-CLK (1 mM) was dissolved in DMF-water (1:2, 3 mL). To this solution, 5′-GMP (5 mM) and sodium ascorbate (5 mM) were added, and the mixture was incubated at 37° C. for 150 hours. The deep brown solution was lyophilized. Resulting residue was dissolved in water and analyzed by MALDI-TOF-MS (FIG. 6).

Cytotoxicity Analysis of Platin-CLK by MTT Assay. The cytotoxicity of Platin-Az, Platin-CLK, ADIBO-COOH, and cisplatin was tested in PC3 and DU145 cells by the MTT assay. PC3 and DU-145 cells at a density of 2000 cells/well were plated on a 96 well plate and allowed to grow and attach overnight. The media was changed and increasing concentrations of each compound was added. Stock concentrations of different drugs were made using PBS and DMSO, viz., cisplatin (1 mM in PBS), Platin-Az (10 mM in DMSO), Platin-CLK (10 mM in DMSO) and ADIBO-COOH (40 mM in DMSO). Final working solutions were prepared in culture media (RPMI) by keeping total DMSO percentage <1%. These were then incubated for 72 hours. After the incubation, MTT was added (5 mg/mL, 20 μL/well) and incubated for 5 hours in order for MTT to be reduced to purple formazan. The media was removed and the cells were lysed with 100 μL of DMSO. In order to homogenize the formazan solution, the plates were subjected to 10 min of gentle shaking and the absorbance was read at 550 nm with a background reading at 800 nm via plate reader. Cytotoxicity was expressed as mean percentage increase relative to the unexposed control±SD. Control values were set at 0% cytotoxicity or 100% cell viability (FIG. 7). Cytotoxicity data (where appropriate) was fitted to a sigmoidal curve and a three parameters logistic model used to calculate the IC50, which is the concentration of chemotherapeutics causing 50% inhibition in comparison to untreated controls. The mean IC50 is the concentration of agent that reduces cell growth by 50% under the experimental conditions and is the average from at least three independent measurements that were reproducible and statistically significant. The IC50 values were reported at ±99% confidence intervals. This analysis was performed with GraphPad Prism (San Diego, U.S.A).

Synthesis of Platin-Cy5.5. Platin-Az (1.05 mg, 0.0017 mmol) and ADIBO-Cy5.5 (4.0 mg, 0.0034 mmol) were dissolved in 1.5 mL of dry DMF and this mixture was stirred at room temperature for 12 hours. DMF was evaporated under reduced pressure. The rotavap water bath temperature was kept at not more than 40° C. The crude product was suspended in CH₂Cl₂:CH₃CN mixture and precipitated with diethyl ether (0.5:2.5:7) by keeping at −80° C. for 12 hours. The isolated product was washed with small amount of cold dichloromethane and acetonitrile and dried under high vacuum to get deep violet blue color solid. Yield, 3.9 mg, 65%. The formation of Platin-Cy5.5 was confirmed by ¹H NMR and by comparing the UV-visible spectrum of Platin-Cy5.5 with its starting materials (FIG. 8).

Cellular Uptake of Platin-Cy5.5 by Confocal Microscopy. PC3 cells were cultured on a live cell imaging glass bottom dish at a density of 1×106 cells/mL and allowed to grow for 24 hours at 37° C. Cells were treated with 50 μM of Platin-Cy5.5 for 3 hours at 37° C. The cells were washed 5 times with PBS, and live cell imaging were performed in phenol red free RPMI media using Cy5.5 fluorescence channel with 512 millisecond exposure.

Synthesis of PLGA-b-PEG-OH. PLGA-COOH (1.0 g, 0.18 mmol), polyethylene glycol (OH-PEG3350-OH) (1.53 g, 0.512 mmol) and DMAP (0.02 g, 0.170 mmol) were dissolved in dry dichloromethane and stirred for 30 min at 0° C. A solution of DCC (105.6 mg, 0.512 mmol) in dichloromethane was added drop wise to the reaction mixture. Reaction was stirred form 0° C. to room temperature for 18 hours. Precipitated DCU by-product was filtered off and the solution was evaporated by rotavap. This residue was again resuspended/sonicated in ethyl acetate to remove the excess DCU. Solvent was evaporated and the resulting residue was dissolve in 5-10 mL of dichloromethane and precipitated with 40-45 mL of 1:1 mixture of methanol:diethylether and centrifuged. This process was repeated (5×) till the supernatant becomes clear solution. Resulting residue was dried under high vacuum to get white solid polymer. Yield, 469 mg, 30%. ¹H NMR (CDCl₃, 400 MHz): δ 5.21 (m), 4.82 (m), 3.64 (s), 1.59 (m) ppm. ¹³C NMR (CDCl₃, 100 MHz): δ 169.31, 166.31, 70.55, 69.01, 60.79, 16.66 ppm. Gel permeation chromatography: Mn=7262 g/mol, Mw=9929 g/mol, Mz=13508 g/mol, PDI=1.36 (FIG. 9).

Preparation of Platin-CLK Encapsulated PLGA-PEG Polymeric Nanoparticles. Platin-CLK encapsulated polymeric NPs were prepared by nanoprecipitation method. PLGA-b-PEG-OH (50 mg/mL) and Platin-CLK (5 mg/mL) was dissolved in DMF. Varying amounts of Platin-CLK (0, 0.25, 0.50, 1.0, 1.5, 2.0, 2.5 mg/mL in DMF) were added to the PLGA-b-PEG-OH solution to a final polymer solution of 5 mg/mL. These solutions were added dropwise in to vigorously stirring nanopure water (10 mL) and stirred at room temperature for 2 hours. This solution was then filtered and washed three times with nanopure water using 100 KDa MW Amicon filters in order to ensure the removal of all residual organic solvent and free drug. Finally, these polymeric NPs were resuspended in nanopure water (1 mL) and filtered through a 0.2 micron filter. Sizes and charge of the NPs were measured by DLS and zeta potential respectively (FIG. 10). Amounts of Platin-CLK encapsulated inside the polymeric nanoparticles were quantified by measuring the contents of Pt by ICP-MS.

Sample Preparation for TEM Analysis. Dilute solutions of the polymeric NPs in nanopure water were deposited on carbon coated copper grids [Cat. No. 71150, CF300-Cu, Electron Microscopy Science (EMS), Hatfield, Pa.] by drop cast method. Excess water was removed carefully by touching the edge of the grids with a small piece of filter paper following drying at room temperature. Samples were then stained with a drop of 2% weight/volume uranyl acetate in water, excess staining agent was removed by filter paper, and the grids were dried at ambient temperature for 20 min and used for TEM imaging.

The complete disclosure of all patents, patent applications, and publications, and electronically available material (e.g., GenBank amino acid and nucleotide sequence submissions; and protein data bank (pdb) submissions) cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

1. A method of preparing a heterocyclic compound, the method comprising:
providing at least one 1,3-dipole-functional platinum(IV) compound;
contacting the at least one 1,3-dipole functional platinum(IV) compound with at least one cyclic alkyne; and
allowing the at least one 1,3-dipole-functional platinum(IV) compound and the at least one cyclic alkyne to react under conditions effective for a cycloaddition reaction to form the heterocyclic compound.

2. The method of claim 1 wherein the 1,2-dipole-functional platinum(IV) compound is of the formula: 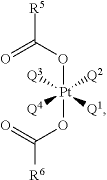
wherein:
each Q¹, Q², Q³, and Q⁴ independently represents a neutral or negatively charged ligand, with the proviso that at most two of Q¹, Q², Q³, and Q⁴ can represent negatively charged ligands, and wherein two or more of Q¹, Q², Q³, and Q⁴ can optionally be joined to form one or more five- or six-membered platinocyclic rings; and
R⁵ and R⁶ each independently represent an organic group, with the proviso that at least one of R⁵ and R⁶ includes a 1,3-dipole-functional group.

3. The method of claim 2 wherein two of Q¹, Q², Q³, and Q⁴ represent negatively charged ligands, and the resulting platinum(IV) compound is neutral.

4. The method of claim 2 wherein only one of Q¹, Q², Q³, and Q⁴ represents a negatively charged ligand, the resulting platinum(IV) compound bears a single positive charge (+1), and the platinum (IV) compound is a salt that includes a single negatively charged (−1) counterion.

5. The method of claim 2 wherein none of Q¹, Q², Q³, and Q⁴ represents a negatively charged ligand, the resulting platinum(IV) compound bears a positive charge of +2, and the platinum (IV) compound is a salt that includes a single counter ion having a charge of −2 or two single negatively charged (−1) counterions.

6-7. (canceled)

8. The method of claim 2 wherein Q¹, Q², Q³, and Q⁴ form monodentate lagands, bidentate ligands, tridentate ligands, tetradentate ligands, or a combination thereof.

9. The method of claim 1 wherein the 1,2-dipole-functional platinum(IV) compound is of the formula: 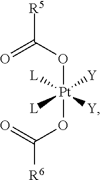
wherein:
each Y independently represents a negatively charged ligand, wherein both Y ligands may optionally be joined to form a five- or six-membered platinocyclic ring;
each L independently represents a neutral ligand, wherein both L ligands may optionally be joined to form a five- or six-membered platinocyclic ring; and
R⁵ and R⁶ each independently represent an organic group, with the proviso that at least one of R⁵ and R⁶ comprises a 1,3-dipole-functional group.

10. The method of claim 9 wherein each Y is independently selected from the group consisting of halides, alkoxides, aryloxides, carboxylates, sulfates, and combinations thereof.

11. The method of claim 9 wherein both Y ligands taken together represent a dianionic oxalate ligand.

12. The method of claim 9 wherein each L independently represents NR⁷R⁹₂, wherein each R⁷ and R⁹ independently represents H or an organic group, and wherein an R⁷ organic group from each L can optionally be joined to form a five- or six-membered platinocyclic ring.

13. The method of claim 2 wherein at least one of R⁵ and R⁶ represents the group —(CH₂)ₙ-G, wherein G represents a 1,3-dipole-functional group, and n=1 to 18.

14. The method of claim 2 wherein the 1,3-dipole-functional group is selected from the group consisting of an azide group, a nitrile oxide group, a nitrone group, an azoxy group, and combinations thereof.

15. The method of claim 1 wherein the platinum(IV) compound is of the formula:

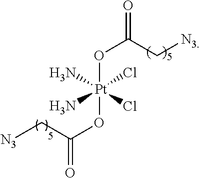

16. The method of claim 1 wherein the platinum(IV) compound is of the formula: 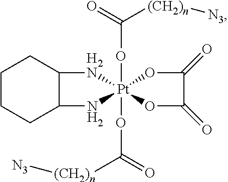
wherein each n is independently 1 to 18.

17. The method of claim 1 wherein the platinum(IV) compound is of the formula: 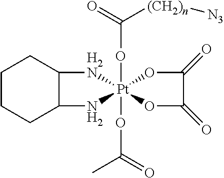
wherein n=1 to 18.

18-19. (canceled)

20. The method of claim 1 wherein at least one cyclic alkyne is of the formula: 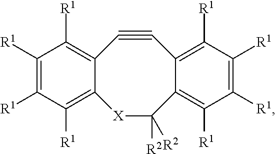
wherein:
each R¹ is independently selected from the group consisting of hydrogen, halogen, hydroxy, alkoxy, nitrate, nitrite, sulfate, an organic group, a targeting group, an adjuvant, an antibody, a therapeutic, a dye, a sensor, a reporter, a biological polymer, a synthetic polymer, a particle, a vesicle, and an organic group attached to a surface;
X represents C═O, C═N—OR³, C═N—NR³R⁴, CHOR³, CHNHR³, BR³, NR³, N(CO)R³, O, SiR³R⁴, PR³, O═PR³, or halogen; and
each R², R³, and R⁴ is independently selected from the group consisting of hydrogen, an organic group, a targeting group, an adjuvant, an antibody, a therapeutic, a dye, a sensor, a reporter, a biological polymer, a synthetic polymer, a particle, a vesicle, and an organic group attached to a surface.

21. The method of claim 20 wherein each R¹ independently represents hydrogen or a C1-C10 organic group.

22-26. (canceled)

27. A heterocyclic compound of the formula: 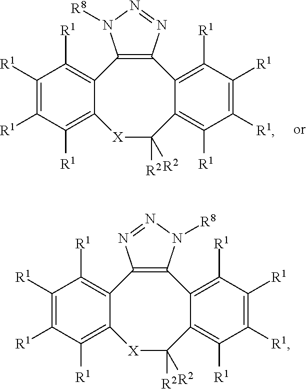
wherein:
each R¹ is independently selected from the group consisting of hydrogen, halogen, hydroxy, alkoxy, nitrate, nitrite, sulfate, an organic group, a targeting group, an adjuvant, an antibody, a therapeutic, a dye, a sensor, a reporter, a biological polymer, a synthetic polymer, a particle, a vesicle, and an organic group attached to a surface;
X represents C═O, C═N—OR³, C═N—NR³R⁴, CHOR³, CHNHR³, BR³, NR³, N(CO)R³, O, SiR³R⁴, PR³, O═PR³, or halogen;
each R², R³, and R⁴ is independently selected from the group consisting of hydrogen, an organic group, a targeting group, an adjuvant, an antibody, a therapeutic, a dye, a sensor, a reporter, a biological polymer, a synthetic polymer, a particle, a vesicle, and an organic group attached to a surface; and
R⁸ represents an organic group comprising a platinum(IV) compound.

28-42. (canceled)

43. A compound having one or more heterocyclic groups prepared by a method according to claim 1.

44. A compound of the formula: [chemical structure]
